(19) United States
(12) Patent Application Publication
(10) Pub. No.: US 2009/0256802 A1
(43) Pub. Date: Oct. 15, 2009

(54) KEYBOARD WITH OPTICAL CURSOR CONTROL DEVICE

(75) Inventors: Chin-Kuan Lou, Taipei (TW); Chih-Wen Su, Taipei (TW)

Correspondence Address: KIRTON AND MCCONKIE, 60 EAST SOUTH TEMPLE,, SUITE 1800, SALT LAKE CITY, UT, 84111, US

(73) Assignee: Primax Electronics Ltd., Taipei (TW)

(21) Appl. No.: 12/246,122

(22) Filed: Oct. 6, 2008

(30) Foreign Application Priority Data
Apr. 11, 2008 (TW) 097113210

(51) Int. Cl. G06F 3/033

(52) U.S. Cl. 345/157

(57) ABSTRACT

The present invention relates to a keyboard with an optical cursor control device. The keyboard includes a plurality of keys and the optical cursor control device. These keys contain a space bar. The optical cursor control device may generate a cursor control signal by sensing movement of a user's finger. The optical cursor control device is arranged in the vicinity of the space bar. As a result, the user can operate the optical cursor control device without the need of considerably changing the hand gesture.

### FIELD OF THE INVENTION

The present invention relates to a keyboard, and more particularly to a keyboard with an optical cursor control device.

### BACKGROUND OF THE INVENTION

With increasing development of high technology industries, computers are widely used in our daily lives, or otherwise employed for working or amusement purposes. Among the peripheral devices of the computer systems, keyboards are essential bridges between the users and the computer systems. Recently, keyboards have experienced great growth and are now rapidly gaining in popularity. In addition to the common wired keyboards, diverse keyboards can be employed with the computer systems to achieve various purposes. Examples of these diverse keyboards include a wireless keyboard, a keyboard with a touch pad, a keyboard with a hot key, an ergonomic keyboard, a keyboard with a cursor control device and the like.

The subject of the present invention relates to a keyboard with an optical cursor control device. FIG. 1 is a schematic top view illustrating a keyboard with a cursor control device according to the prior art. The keyboard 100 includes a plurality of keys 101 and a cursor control device 102. When the keys 101 are depressed, corresponding characters, numbers or signs are inputted into the computer system (not shown). Generally, the cursor control device 102 is applied to a notebook computer and arranged among several keys 101. When a user touches the cursor control device 102 with a finger, an electronic signal indicative of the magnitude and the direction of the force exerted by the user will be generated. In response to the electronic signal, the cursor control device 102 causes corresponding movement of the cursor on the computer screen. The use of the cursor control device 102 in the keyboard 100 may replace the mouse for controlling cursor movement.

FIG. 2 is a schematic perspective view of a conventional cursor control device used in a notebook computer. A key 101 beside the cursor control device 102 has an extension part 103 with an opening 104. The cursor control device 102 is substantially a control rod inserted into the opening 104 such that the cursor control device 102 is attached on the key 101. When the keyboard 100 is used, one or more keys 101 are depressed by the fingers of the user to input characters, numbers or signs into the computer system in a message-inputting mode. For moving the cursor shown on the computer screen in a cursor control mode, a specified finger (e.g. the forefinger) of the user should be moved to the cursor control device 102 in order to operate the cursor control device 102. After the cursor is moved to a desired position, the hand gesture is switched to place the fingers on one or more keys in order to depress keys. Since the hand gesture is frequently switched between the message-inputting mode and the cursor control mode if the keyboard 100 has been used for a long term, the user may of the feel fatigued. In addition, frequently switching the hand gesture between the message-inputting mode and the cursor control mode is not only time-consuming but also inconvenient.

Therefore, there is a need of providing a keyboard for inputting characters and controlling cursors without the need of considerably changing the hand gesture.

### SUMMARY OF THE INVENTION

It is an object of the present invention to provide a keyboard for inputting characters and controlling cursors without the need of considerably changing the hand gesture.

In accordance with an aspect of the present invention, there is provided a keyboard with an optical cursor control device. The keyboard includes a plurality of keys and the optical cursor control device. These keys are depressed to input corresponding characters or signs and contain a space bar and the remainder keys. The optical cursor control device is arranged in the vicinity of the space bar for generating a cursor control signal by sensing movement of a user's finger. The optical cursor control device includes a light source, an optical member, a sensor and an upper cover. The light source is used for emitting light beams. The optical member may reflect the light beams to the user's finger and focus the light beams reflected by the user's finger. The sensor is used for receiving the focused light beams and generating the cursor control signal according to the focused light beams. The upper cover shelters the optical member and has a light-penetrable transparent portion, wherein the upper cover is exposed to a surface of the keyboard for allowing the user's finger to be placed thereon.

In an embodiment, the light source and the sensor are mounted in a same package, and the optical member is disposed above the package.

In an embodiment, the space bar has a first side near the remainder keys and a second side distant from the remainder keys, and the optical cursor control device is arranged in the vicinity of the second side of the space bar.

In an embodiment, the keyboard further includes a support member, wherein a tab is extended from the support member at the location corresponding to the second side of the space bar for supporting the optical cursor control device.

In accordance with another aspect of the present invention, there is provided a keyboard with an optical cursor control device. The keyboard includes a plurality of keys and the optical cursor control device. These keys are depressed to input corresponding characters or signs and contain two space bars. The optical cursor control device is arranged between the two space bars for generating a cursor control signal by sensing movement of a user's finger. The optical cursor control device includes a light source, an optical member, a sensor and an upper cover. The light source is used for emitting light beams. The optical member may reflect the light beams to the user's finger and focus the light beams reflected by the user's finger. The sensor is used for receiving the focused light beams and generating the cursor control signal according to the focused light beams. The upper cover shelters the optical member and has a light-penetrable transparent portion, wherein the upper cover is exposed to a surface of the keyboard for allowing the user's finger to be placed thereon.

In an embodiment, the light source and the sensor are mounted in a same package, and the optical member is disposed above the package.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating a keyboard with a cursor control device according to the prior art;

FIG. 2 is a schematic perspective view of a conventional cursor control device used in a notebook computer;

FIG. 3 is a schematic cross-sectional view illustrating an optical cursor control device used in the keyboard of the present invention;

FIG. 4 is a schematic top view illustrating a keyboard with an optical cursor control device according to a first preferred embodiment of the present invention; and

FIG. 5 is a schematic top view illustrating a keyboard with an optical cursor control device according to a second preferred embodiment of the present invention.

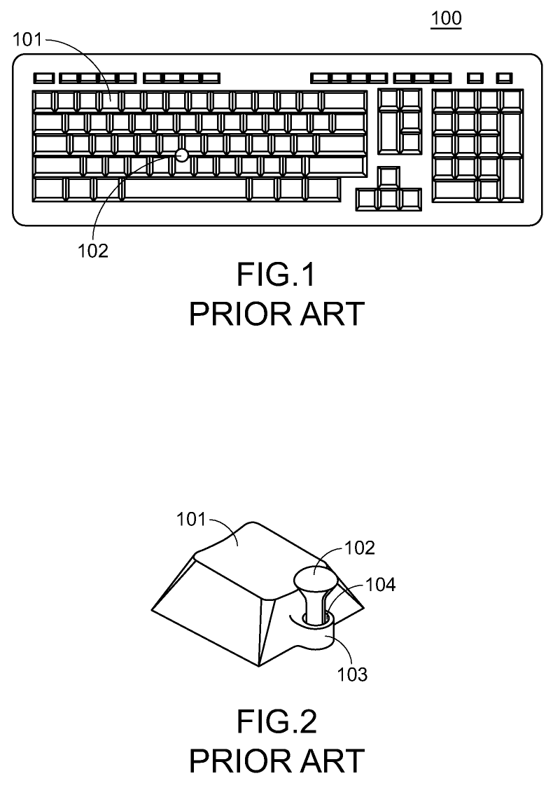

### DETAILED DESCRIPTION OF THE PREFERRED EMBODIMENT

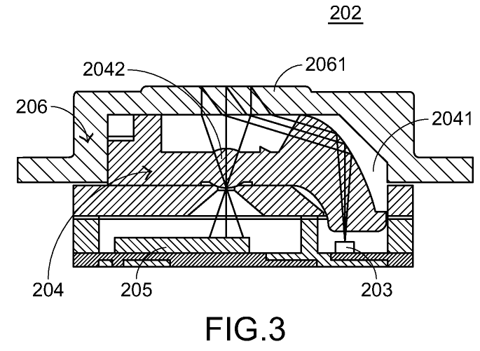

The present invention relates to a keyboard with an optical cursor control device. The operating principle of the optical cursor control device will be illustrated as follows with reference to FIG. 3. FIG. 3 is a schematic cross-sectional view illustrating an optical cursor control device used in the keyboard of the present invention.

The optical cursor control device 202 comprises a light source 203, an optical member 204, a sensor 205 and an upper cover 206. The light source 203 and the sensor 205 are mounted within a same package. The optical lens 204 is arranged on the package. The light source 203 is used for emitting light beams. The optical member 204 includes a reflective mirror 2041 and a focusing lens 2042. The upper cover 206 is disposed above the optical member 204 for sheltering the optical member 204. The light beams emitted by the light source 203 are reflected by the reflective mirror 2041 and then projected on a surface of the user's finger (not shown), which is placed on the upper cover 206. The light beams reflected by the user's finger are focused onto the sensor 205 by the focusing lens 2042. In receipt of the focused light beams, the sensor 205 generates a cursor control signal. The upper cover 206 has a transparent portion 2061. When the user's finger is placed on the upper cover 206, the light beams reflected from the reflective mirror 2041 can pass through the transparent portion 2061 of the upper cover 206 to be projected on the surface of the user's finger. Alternatively, all of the upper cover 206 can be made of transparent material such that the light beams reflected from the reflective mirror 2041 can pass through the upper cover 206 to be projected on the surface of the user's finger.

Please refer to FIG. 3 again. The light beams emitted by the light source 203 are reflected by the reflective mirror 2041 and then projected on a surface of the user's finger through the transparent portion 2061 of the upper cover 206. Next, the light beams reflected by the user's finger are focused onto the sensor 205 by the focusing lens 2042. In receipt of the focused light beams, the sensor detects information associated with the fingerprint of the user. According to change of the fingerprint information, a corresponding cursor control signal is generated.

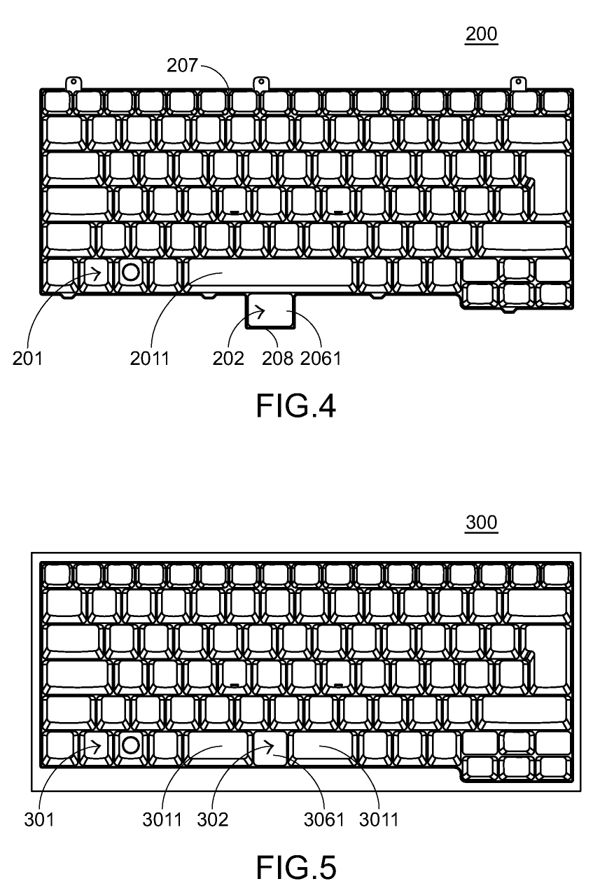

FIG. 4 is a schematic top view illustrating a keyboard with an optical cursor control device according to a first preferred embodiment of the present invention. The keyboard 200 of FIG. 4 is applicable to for example a notebook computer. The keyboard 200 comprises a support member 207, a plurality of keys 201 and the optical cursor control device 202. The keys 201 and the optical cursor control device 202 are mounted on the support member 207 so as to assemble a modular keyboard 200. When the keys 201 are depressed, corresponding characters, numbers or signs are inputted into the notebook computer which the modular keyboard 200 is mounted thereon. The keys 201 contain a space bar 2011 and other keys (also referred as the remainder keys 201). The optical cursor control device 202 is arranged in the vicinity of the space bar 2011. The space bar 2011 has a first side near the remainder keys 201 and a second side distant from the remainder keys 201. In this embodiment, the optical cursor control device 202 is arranged in the vicinity of the second side of the space bar 2011. Moreover, a tab 208 is extended from the support member 207 at the location corresponding to the second side of the space bar 2011. The optical cursor control device 202 is supported on the tab 208.

For inputting characters, numbers or signs into the notebook computer in the message-inputting mode, the palms of the both hands may be rested on the keyboard 20 and the thumbs of both hands may be arranged adjacent to the space bar 2011. That is, in the message-inputting mode, the way of arranging the hand gesture is identical to that used in the conventional keyboard. For moving the cursor shown on the computer screen in a cursor control mode, slightly moving a thumb to the optical cursor control device 202 is necessary while the hand gestures associated with the message-inputting actions are maintained changed. That is, the keyboard of the present invention can be used for inputting characters and controlling cursors without the need of changing the hand gesture. Moreover, since the optical cursor control device 202 generates the cursor control signal by the optical sensing means, the optical cursor control device 202 has good sensitivity. By slightly touching the transparent portion 2061 of the upper cover 206, the cursor control signal will be generated.

FIG. 5 is a schematic top view illustrating a keyboard with an optical cursor control device according to a second preferred embodiment of the present invention. The keyboard 300 of FIG. 5 is used as for example an external keyboard of a desktop computer. The keyboard 300 comprises a plurality of keys 301 and the optical cursor control device 302. The keys 301 contain two space bars 3011 and other keys (also referred as the remainder keys 301). The structure of the optical cursor control device 302 is identical to that of the optical cursor control device 202 shown in FIG. 3, and is not redundantly described herein. In comparison with the keyboard 300 of FIG. 4, the keyboard 300 of FIG. 5 has two space bars 3011 and the optical cursor control device 302 is arranged between these two space bars 3011. Such a keyboard 300 is also advantageously operated. It is noted that, however, those skilled in the art will readily observe that numerous modifications and alterations may be made while retaining the teachings of the invention. For example, the keyboard 300 may be applied to a notebook computer and the optical cursor control device is also arranged between the two space bars. Furthermore, in a case that the external keyboard has only a space bar, the optical cursor control device may be arranged beside the space bar, as is similar to FIG. 4.

From the above description, since the optical cursor control device of the keyboard of the present invention is arranged in the vicinity of the space bar, the user can operate the optical cursor control device without the need of considerably changing the hand gesture on the keyboard. In comparison with the conventional keyboard, the user can operate the optical cursor control device in a time-saving and labor-saving manner. In addition, the optical cursor control device of the present invention has simplified configuration so that the possibility of causing an erroneous operation or a breakdown (which is commonly found in the conventional cursor control device) is largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keyboard with an optical cursor control device, said keyboard comprising:
a plurality of keys depressed to input corresponding characters or signs, wherein said plurality of keys contain a space bar and the remainder keys; and
said optical cursor control device arranged in the vicinity of said space bar for generating a cursor control signal by sensing movement of a user's finger, said optical cursor control device comprising:
a light source for emitting light beams;
an optical member for reflecting said light beams to said user's finger and focusing said light beams reflected by said user's finger;
a sensor for receiving said focused light beams and generating said cursor control signal according to said focused light beams; and
an upper cover sheltering said optical member and having a light-penetrable transparent portion, wherein said upper cover is exposed to a surface of said keyboard for allowing said user's finger to be placed thereon.

2. The keyboard with an optical cursor control device according to claim 1 wherein said light source and said sensor are mounted in a same package, and said optical member is disposed above said package.

3. The keyboard with an optical cursor control device according to claim 1 wherein said space bar has a first side near said remainder keys and a second side distant from said remainder keys, and said optical cursor control device is arranged in the vicinity of said second side of said space bar.

4. The keyboard with an optical cursor control device according to claim 3 further comprising a support member, wherein a tab is extended from said support member at the location corresponding to said second side of said space bar for supporting said optical cursor control device.

5. A keyboard with an optical cursor control device, said keyboard comprising:
a plurality of keys depressed to input corresponding characters or signs, wherein said plurality of keys contain two space bars; and
said optical cursor control device arranged between said two space bars for generating a cursor control signal by sensing movement of a user's finger, said optical cursor control device comprising:
a light source for emitting light beams;
an optical member for reflecting said light beams to said user's finger and focusing said light beams reflected by said user's finger;
a sensor for receiving said focused light beams and generating said cursor control signal according to said focused light beams; and
an upper cover sheltering said optical member and having a light-penetrable transparent portion, wherein said upper cover is exposed to a surface of said keyboard for allowing said user's finger to be placed thereon.

6. The keyboard with an optical cursor control device according to claim 5 wherein said light source and said sensor are mounted in a same package, and said optical member is disposed above said package.
